(19) United States
(12) Patent Application Publication
(10) Pub. No.: US 2024/0104339 A1
(43) Pub. Date: Mar. 28, 2024

(54) METHOD AND SYSTEM FOR AUTOMATIC IMPROVEMENT OF CORRUPTION ROBUSTNESS

(71) Applicant: Robert Bosch GmbH, Stuttgart (DE)

(72) Inventors: Mohammad Sadegh NOROUZZADEH, Pittsburgh, PA (US); Shabaz REZAEE, Davis, CA (US)

(21) Appl. No.: 17/949,745

(22) Filed: Sep. 21, 2022

(51) Int. Cl. G06N 3/04

(52) U.S. Cl. CPC G06N 3/04

(57) ABSTRACT

A computer-implemented method for training a machine-learning network. A computer-implemented method for training a machine-learning network includes generating a frequency spectrum associated with the input data, wherein the generating includes creating the frequency spectrum by applying a frequency domain transformation on the input data, normalizing the frequency spectrum to generate a normalized frequency spectrum, sending the normalized frequency spectrum to a hyper model configured classifying corruptions, utilizing the normalized frequency spectrum as input to the hyper model in order to classify a corruption associated with the input data, updating one or more weights associated with the classifier based on the corruption associated with the input data, and outputting a classification associated with the input data utilizing the classifier with updated weights.

### TECHNICAL FIELD

The present disclosure relates to augmentation and processing of an image (or other inputs) utilizing machine learning.

### BACKGROUND

In recent years, deep neural networks (DNNs) have been widely adopted to solve various vision tasks. At inference time, DNNs generally perform well on data points sampled from the same distribution as the training data. However, they often perform poorly on data points of different distribution, including corrupted data, such as noisy or blurred images. These corruptions often appear naturally at inference time in many applications, such as cameras in autonomous cars, x-ray images, Lidar images, etc. Not only does DNNs' accuracy drops across shifts in the data distribution, but also the well-known overconfidence problem of DNNs impedes the detection of domain shift.

Deep learning image classifiers may predict wrong results for images changed by corruption such as Gaussian noise, snow, blur, pixilation, or combinations of them. Dissimilar to adversarial attacks, these corruptions may naturally exist in many real world sensory data and can degrade accuracy of machine learning models. Robustness against these types of corruptions may be crucial for using machine learning models in real world applications, especially for those involving safety-critical tasks.

Augmenting training data with corrupted images may be a way to enhance corruption robustness. However, this approach requires retraining the model on the augmented training set and, at the end, the model might be still vulnerable to other types of corruption which were not included in the augmented data. Moreover, improving robustness against one type of corruptions may degrade model's accuracy on other types of corruptions. For example, although Gaussian noise augmentation increases the robustness against Gaussian noise as expected, it decreases the robustness against contrast and fog corruptions. One approach to improve the robustness against various corruptions is to augment the training data to cover various corruptions. Recently, many more advanced data augmentation schemes have also been proposed and shown to improve the model robustness on corrupted data. However, these approaches require computationally expensive training or re-training process.

Furthermore, update batch normalization (BN) statistics to adopt the trained DNN to a new domain or corruption is another approach. Although this approach is an efficient and effective way to improve robustness, and it does not require retraining the model from scratch, it cannot handle a wide range of corruptions at the same time and can only perform well on a single type of corruption (domain) or at the best multiple types of similar corruptions it is tuned for.

A simple batch normalization (BN) statistics update may improve the robustness of a pre-trained model against various corruptions with minimal computational overhead. For example, the system may only update the BN statistics of a pre-trained model on a target corruption. If the corruption is not known beforehand, the model BNs can be updated constantly at inference time to adopt to the ongoing corruption. Despite its effectiveness, this approach may only be suitable when a constant flow of inputs with a same corruption is fed to the model so that it can adjust the BN stats accordingly.

### SUMMARY

A first embodiment discloses, a computer-implemented method for training a machine-learning network. A computer-implemented method for training a machine-learning network includes generating a frequency spectrum associated with the input data, wherein the generating includes creating the frequency spectrum by applying a frequency domain transformation on the input data, normalizing the frequency spectrum to generate a normalized frequency spectrum, sending the normalized frequency spectrum to a hyper model configured classifying corruptions, utilizing the normalized frequency spectrum as input to the hyper model in order to classify a corruption associated with the input data, updating one or more weights associated with the classifier based on the corruption associated with the input data, and outputting a classification associated with the input data utilizing the classifier with updated weights.

A second embodiment discloses a system including a machine-learning network. The system includes an input interface configured to receive input data from a sensor, wherein the sensor includes a camera, a radar, a sonar, or a microphone. The system also includes a processor, in communication with the input interface, wherein the processor is programmed to receive an input data from a sensor, wherein the input data is indicative of image, radar, sonar, or sound information, generate a frequency spectrum associated with the input data, wherein the generating includes creating the frequency spectrum by applying a frequency domain transformation on the input data, normalize the frequency spectrum to generate a normalized frequency spectrum, send the normalized frequency spectrum to a hyper model configured classifying corruptions, utilizing the normalized frequency spectrum as input to the hyper model in order to classify a corruption associated with the input data, update one or more weights associated with the classifier based on the corruption, and output a classification associated with the input data utilizing the classifier with updated weights.

A third embodiment discloses, a computer-program product storing instructions which, when executed by a computer, cause the computer to receive an input data from a sensor, generate a frequency spectrum associated with the input data by applying a frequency domain transformation on the input data, normalize the frequency spectrum to generate a normalized frequency spectrum, inputting the normalized frequency spectrum to a hyper model configured classifying corruptions, classify a corruption associated with the input data based on an output of the hyper model, update the classifier based on the corruption, and output a classification associated with the input data utilizing the updated classifier.

### BRIEF DESCRIPTION OF THE DRAWINGS

FIG. 1 shows a system 100 for training a neural network.

FIG. 2 depicts a data annotation system 200 to implement a system for annotating data.

FIG. 3 depicts an illustrative overview of the system utilizing a hyper model.

FIG. 4 depicts a normalized Fourier spectrum of different corruption types.

FIG. 5 depicts a schematic diagram of an interaction between computer-controlled machine 10 and control system 12.

FIG. 6 depicts a schematic diagram of the control system of FIG. 1 configured to control a vehicle, which may be a partially autonomous vehicle or a partially autonomous robot.

FIG. 7 depicts a schematic diagram of the control system of FIG. 1 configured to control a manufacturing machine, such as a punch cutter, a cutter or a gun drill, of manufacturing system, such as part of a production line.

FIG. 8 depicts a schematic diagram of the control system of FIG. 1 configured to control a power tool, such as a power drill or driver, that has an at least partially autonomous mode.

FIG. 9 depicts a schematic diagram of the control system of FIG. 1 configured to control an automated personal assistant.

FIG. 10 depicts a schematic diagram of the control system of FIG. 1 configured to control a monitoring system, such as a control access system or a surveillance system.

FIG. 11 depicts a schematic diagram of the control system of FIG. 1 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

DNNs trained on natural clean samples have been shown to perform poorly on corrupted samples, such as noisy or blurry images. Various data augmentation methods have been recently proposed to improve DNN's robustness against corruptions. Despite their success, they require computationally expensive training which impedes their use on off-the-shelf trained models. Recently, updating only batch normalization (BN) statistics of a model on a corruption has been shown to significantly improve its accuracy on that corruption. However, adopting the idea at inference time when corruption type changes decrease the effectiveness of this method. In this disclosure, the system and method of the task of detecting the corruption type is easy on Fourier-domain despite being difficult on image-domain. Hence, the system and method may propose a unified framework consisting of a corruption-detection model and BN statistics update that can be adopted to any off-the-shelf trained model to improve corruption accuracy. The system and method may allow for an accuracy improvement of about 8% and 4% on CIFAR10-C and ImageNet-C, respectively. Furthermore, the framework can further improve the accuracy of state-of-the-art robust models, such as AugMix and DeepAug.

In the non-limiting example disclosed below, the method and system may investigate how hard the corruption type detection task itself would be. While the corruption type detection is a complicated one in image domain, the corruption type may be more easy to identify in Fourier domain because each corruption may have a relatively unique frequency profile. This may allow a very shallow and small DNN to modestly detect corruption types when fed with a specifically normalized frequency spectrum.

Given that corruption type can be easily detected using the Fourier domain, the system and method may adopt the BN statistic update method such that it can change the BN values dynamically based on the current corruption. A Fourier transform of the image is taken and, after applying a specifically designed normalization, it is fed to the corruption type detection DNN. Based on the detected corruption, the corresponding BN statistics are taken from the BN stat lookup table and the pre-trained network BNs are updated accordingly. Finally, the original image is fed to the dynamically updated pre-trained network.

The system and method may show that the frequency spectrum of an image can be easily used to identify the corruption type. On ImageNet-C, a shallow 3-layer fully connected neural network can identify 16 corruption types with approximately 65.88% accuracy. The majority of the misclassifications occurs between similar corruptions, such as different types of noise, for which the BN stat updates are similar nevertheless. The framework disclosed below may be used on any off-the-shelf pre-trained model, even a robustly trained models, and further improve the robustness. However, updating BN statistics at inference time as suggested in may not achieve good performance when the corruption type does not remain for a long time. On the other hand, our framework is insensitive to the rate at which corruption changes and outperform these methods.

The system may include three main components, (i) a DNN trained on the original task, such as object detection, (ii) a DNN trained to detect corruption type, and (iii) a lookup table storing BN statistics corresponding to each corruption. The system may improve natural robustness of trained DNNs. However, the framework can be easily extended to domain generalization and cases where the lookup table may update the entire model weights or even the model architecture itself.

A BN statistic update may improve the natural robustness of trained DNNs significantly. The drawback of their approach is that the BN statistics obtained for a corruption often significantly degrades the accuracy on other corruptions, expect for corruptions that are similar in nature, such as different types of noise. The authors claim that in many applications, such autonomous vehicles, the corruption type will remain the same for considerable amount of time, and consequently, the BN statistics can be updated at inference time. However, neither of those papers have shown the performance of BN statistic update when corruption changes. Detecting corruption types and updating BN stats accordingly achieve better results than when corruption type is not fixed.

The average Fourier spectrum of different corruptions has been shown to visually differ from one corruption to another. However, conducting a corruption classification on Fourier spectrum of individual image may not be a trivial task. Feeding a DNN with the raw Fourier spectrum may lead to poor results and unstable training. Thus, it may be beneficial to investigate the Fourier spectrum of various corruption types. Then, the system may propose a specific normalization approach and a shallow DNN to accurately detect corruption type.

The system may denote an image of size (d₁, d₂)by x ∈ R^{d1×d2}. It may omit the channel dimension because the Fourier spectrum of all channels may be similar. Thus, only results of the first channel may be output. The system may denote natural and corrupted data distribution by Dₙ and D_{c}, respectively. The system denote 2D discrete Fourier transform operation by F. The system and method may consider the amplitude component of F since the phase component does not have any classification signal for corruption detection. Moreover, we shift the low frequency component to the center, for better visualization.

The proposed system and method can perform well on multiple types of corruption without sacrificing much computational power or accuracy on other types of corruption. The method automatically detects the type of corruption based on Fourier transform (or any other frequency domain transformation) of the input. The system and method may not require training the model from scratch, it may only need a few samples from the target domain to adapt. The system and method can independently improve corruption robustness on multiple types of corruption without losing robustness against other types of corruption. Thus, the system and method of the model is adapted to a specific type of corruption, it does not forget its robustness. No matter how the corruption/domain changes later. The system and method disclosed may apply to not only video or images, but could be utilized to other types of data, such as audio signals, Lidar data, and more. Thus it may be utilized for the image classification task but can also improve corruption robustness for other tasks such as object localization/detection, semantic segmentation, and more. With the help of any existing outlier detection method, the system and method below can potentially detect and adopt to new or unseen corruptions by identifying outlier classes at inference time. It can obtain the batch norm statistics at inference time upon seeing a new corruption. This system and method can be extended to detect different type of domains, instead of corruption, such as painting, sketches, etc.

In this disclosure, a system and a method to automatically identify the context (such as, corruption or new domain) and dynamically adapt the model, allowing the model to perform well on that particular context or corruption. Model adaptation may include updating model's parameters, or even architecture of the model. The system may update BN statistics to adapt the model to update weights based on the corruption.

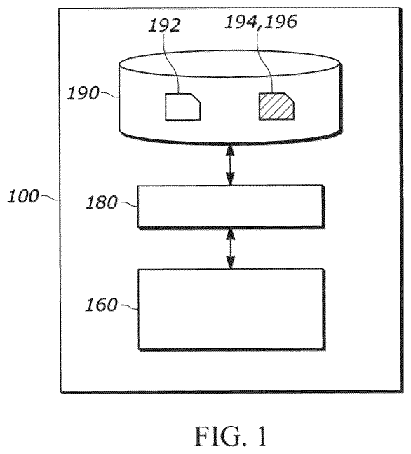

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. In one embodiment, respective layers of the stack of layers being substituted may have mutually shared weights and may receive, as input, an output of a previous layer, or for a first layer of the stack of layers, an initial activation, and a part of the input of the stack of layers. The system may also include multiple layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 196 of the trained neural network, this data may also be referred to as trained model data 196. For example, as also illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may during or after the training be replaced, at least in part by the data representation 196 of the trained neural network, in that the parameters of the neural network, such as weights, hyper parameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

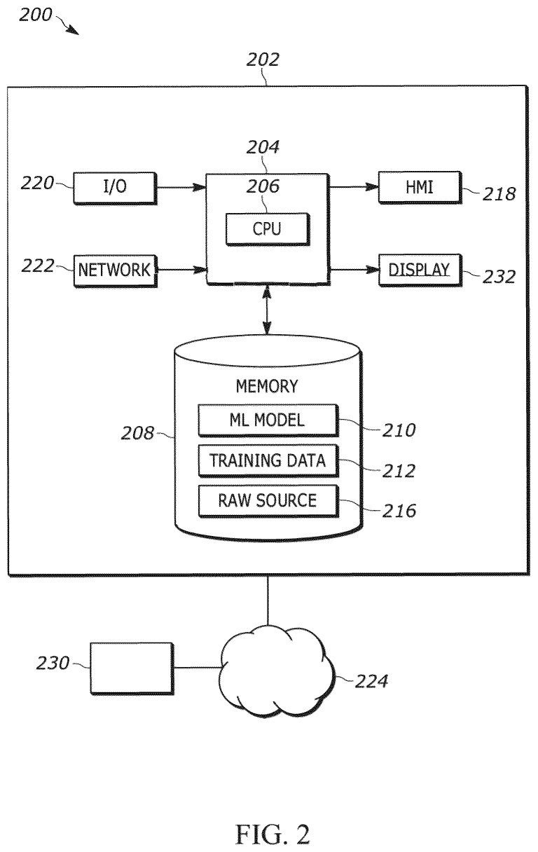

FIG. 2 depicts a data annotation system 200 to implement a system for annotating data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 215.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (1/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 215. The raw source dataset 215 may include raw or unprocessed sensor data that may be representative of an input dataset for a machine-learning system. The raw source dataset 215 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 215. The raw source data 215 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 215 to identify the presence of the particular features. The machine-learning algorithm 210 may be configured to identify a feature in the raw source data 215 as a predetermined feature (e.g., pedestrian). The raw source data 215 may be derived from a variety of sources. For example, the raw source data 215 may be actual input data collected by a machine-learning system. The raw source data 215 may be machine generated for testing the system. As an example, the raw source data 215 may include raw video images from a camera.

In the example, the machine-learning algorithm 210 may process raw source data 215 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

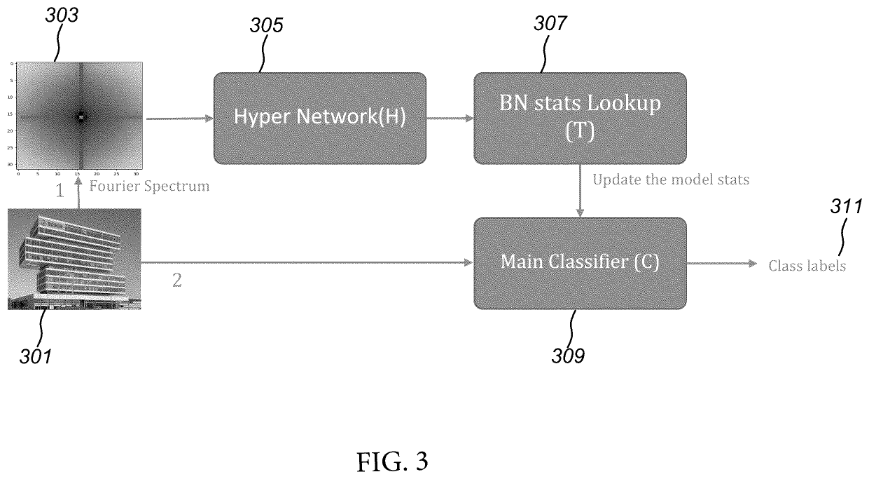

FIG. 3 discloses an illustrative overview of the system utilizing a hyper model. The system may include an input image 301 that is received from one or more sensors, such as a camera, radar, Lidar, etc. The hyper model 305 may identify the type of input corruption, e.g., motion blur or Gaussian noise. In one example, a simple classifier model that takes the Fourier transform of the input image as input and predicts the type of corruption in the image or if it is a clean image. The main classifier model 309 may perform classification on the input image. This model can be a pre-trained model trained only using natural samples without any corruption. The system may include a BN statistics lookup table (T) 307 that contains corresponding values for each type of corruption. BN statistics can be computed from train data, updated at inference time, or inserted at inference time when observing new corruption type. Once the hyper model detects the corruption, it can dynamically choose (or generate) corresponding BN statistics (or, in a more general procedure, even parameters or architecture of the main model) from the lookup table in real-time to make the main model insensitive to that type of corruption. While a look-up table may be utilized, other embodiments may be utilized. For example, the system and method may directly generate the weights. In another embodiment, the system may utilize different models for different corruptions instead of one model for all. In yet another embodiment, the hyper model can change the architecture (e.g. add or drop layers) or algorithm of the main classifier. The system may update the classifier 309 with the corresponding BN statistics. Upon updating the model of the classifier 309, the classifier 309 may output the corresponding classification 311.

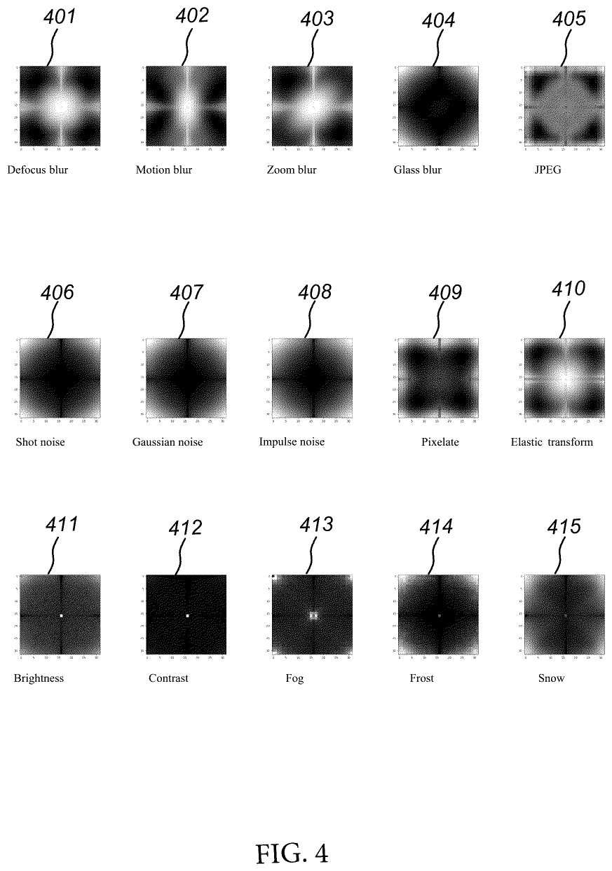

The system may not clip pixel values of the input to the corruption detection model. As shown in FIG. 4 below, most corruption types have distinguishable average Fourier spectrum. The ones that are almost identical, e.g., different type of noise, are not needed to be distinguished accurately as the BN stat updates of one can improve the others nevertheless.

FIG. 4 illustrates a normalized Fourier spectrum of different corruption types. This figure may also illustrate the normalized Fourier spectrum of different corruption types in CIFAR10-C. The normalization process is explained in the next paragraph. The various corruptions identified may include a defocus blur 401, motion blur 402, zoom blur 403, glass blur 404, JPEG 405, shot noise 406, Gaussian noise 407, impulse noise 408, pixelate 409, elastic transform 410, brightness 411, contrast 412, fog 413, frost 414, snow 415, etc.

To normalize the data, the system may first obtain the average Fourier spectrum of the natural samples, denoted by ∈ₙ= [symbol] ₓ˜Dₙ [symbol] F(x) [symbol] . Then, or each corruption, the system may compute normalized Fourier spectrum by

$$log ( \frac{{𝔼}_{x} ∼ {D}_{c} 〚 F ( x ) 〛}{{∈}_{n}} + 1 )$$

for each corruption type, separately. For corruption detection purpose, the system may substitute the expected value over the entire corruption type dataset by individual image, e.g.,

$$log ( \frac{\vert F ( x ) \vert}{{∈}_{n}} + 1 ) .$$

The system may find this specific normalization to outperform others significantly. The intuition behind this normalization may be twofold. First, natural images may have higher concentration in low frequencies and most corruption types may still have large values in low frequency components. Hence, the system may divide the values by ∈ₙ to make sure that model is not exclusively focus only on low frequency components during training. Second, the range of values from one pixel to another one may differ multiple order of magnitude which causes instability during training. Typical normalization techniques on unbounded data, such as tanh or sigmoid transforms, may lead to poor accuracy because values larger than certain point converge to 1 and become indistinguishable. The system may determine that this approach of normalization may outperform others significantly.

A DNN that may be used for corruption type detection may be a three-layer fully connected (FC) neural network. Despite having an image-like structure, the system may avoid using convolutional neutral networks (CNNs), in one embodiment, due to the absence of shift invariance in Fourier spectrum. Due to the duplicate component in the Fourier spectrum, the system may only feed the half of the Fourier spectrum to the model. For CIFAR10, the system ma flatten the 2D data and feed to a model with three FC layers of size 1024, 512, and 16. For ImageNet-C, the system may first use 2D average pooling with kernel size and stride of 2 to reduce the dimension. Then, the system may flatten the output and feed it to a model with three FC layers of size 2058, 512, and 16. Additionally, the system may use ReLu function as non-linearity after the first and second layers.

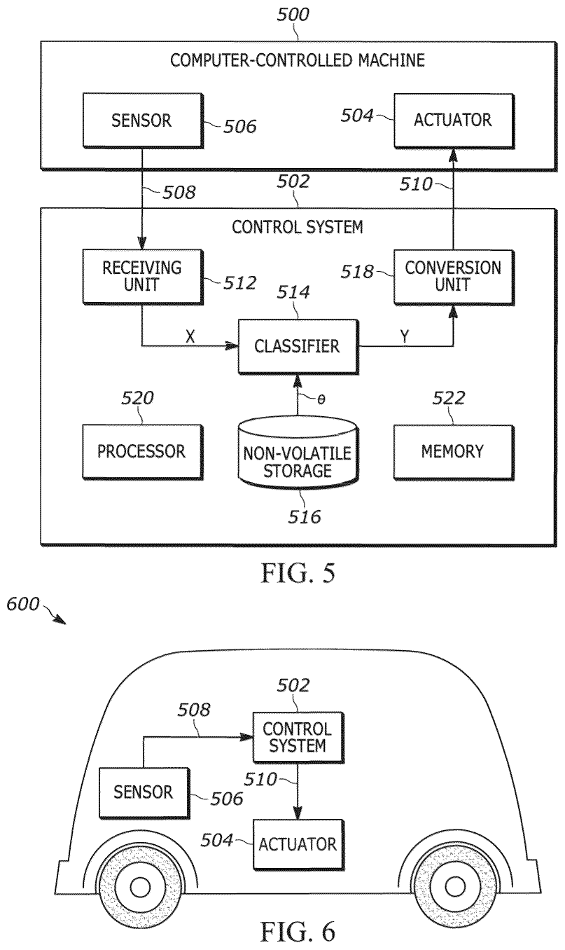

FIG. 5 depicts a schematic diagram of an interaction between computer-controlled machine 10 and control system 12. The computer-controlled machine 10 may include a neural network as described in FIGS. 1-4. The computer-controlled machine 10 includes actuator 14 and sensor 16. Actuator 14 may include one or more actuators and sensor 16 may include one or more sensors. Sensor 16 is configured to sense a condition of computer-controlled machine 10. Sensor 16 may be configured to encode the sensed condition into sensor signals 18 and to transmit sensor signals 18 to control system 12. Non-limiting examples of sensor 16 include video, radar, LiDAR, ultrasonic and motion sensors. In one embodiment, sensor 16 is an optical sensor configured to sense optical images of an environment proximate to computer-controlled machine 10.

Control system 12 is configured to receive sensor signals 18 from computer-controlled machine 10. As set forth below, control system 12 may be further configured to compute actuator control commands 20 depending on the sensor signals and to transmit actuator control commands 20 to actuator 14 of computer-controlled machine 10.

As shown in FIG. 5, control system 12 includes receiving unit 22. Receiving unit 22 may be configured to receive sensor signals 18 from sensor 16 and to transform sensor signals 18 into input signals x. In an alternative embodiment, sensor signals 18 are received directly as input signals x without receiving unit 22. Each input signal x may be a portion of each sensor signal 18. Receiving unit 22 may be configured to process each sensor signal 18 to product each input signal x. Input signal x may include data corresponding to an image recorded by sensor 16.

Control system 12 includes classifier 24. Classifier 24 may be configured to classify input signals x into one or more labels using a machine learning (ML) algorithm, such as a neural network described above. Classifier 24 is configured to be parametrized by parameters, such as those described above (e.g., parameter θ). Parameters θ may be stored in and provided by non-volatile storage 26. Classifier 24 is configured to determine output signals y from input signals x. Each output signal y includes information that assigns one or more labels to each input signal x. Classifier 24 may transmit output signals y to conversion unit 28. Conversion unit 28 is configured to covert output signals y into actuator control commands 20. Control system 12 is configured to transmit actuator control commands 20 to actuator 14, which is configured to actuate computer-controlled machine 10 in response to actuator control commands 20. In another embodiment, actuator 14 is configured to actuate computer-controlled machine 10 based directly on output signals y.

Upon receipt of actuator control commands 20 by actuator 14, actuator 14 is configured to execute an action corresponding to the related actuator control command 20. Actuator 14 may include a control logic configured to transform actuator control commands 20 into a second actuator control command, which is utilized to control actuator 14. In one or more embodiments, actuator control commands 20 may be utilized to control a display instead of or in addition to an actuator.

In another embodiment, control system 12 includes sensor 16 instead of or in addition to computer-controlled machine 10 including sensor 16. Control system 12 may also include actuator 14 instead of or in addition to computer-controlled machine 10 including actuator 14.

As shown in FIG. 5, control system 12 also includes processor 30 and memory 32. Processor 30 may include one or more processors. Memory 32 may include one or more memory devices. The classifier 24 (e.g., ML algorithms) of one or more embodiments may be implemented by control system 12, which includes non-volatile storage 26, processor 30 and memory 32.

Non-volatile storage 26 may include one or more persistent data storage devices such as a hard drive, optical drive, tape drive, non-volatile solid-state device, cloud storage or any other device capable of persistently storing information. Processor 30 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 32. Memory 32 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 30 may be configured to read into memory 32 and execute computer-executable instructions residing in non-volatile storage 26 and embodying one or more ML algorithms and/or methodologies of one or more embodiments. Non-volatile storage 26 may include one or more operating systems and applications. Non-volatile storage 26 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 30, the computer-executable instructions of non-volatile storage 26 may cause control system 12 to implement one or more of the ML algorithms and/or methodologies as disclosed herein. Non-volatile storage 26 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 12 configured to control vehicle 50, which may be an at least partially autonomous vehicle or an at least partially autonomous robot. As shown in FIG. 5, vehicle 50 includes actuator 14 and sensor 16. Sensor 16 may include one or more video sensors, radar sensors, ultrasonic sensors, LiDAR sensors, and/or position sensors (e.g. GPS). One or more of the one or more specific sensors may be integrated into vehicle 50. Alternatively or in addition to one or more specific sensors identified above, sensor 16 may include a software module configured to, upon execution, determine a state of actuator 14. One non-limiting example of a software module includes a weather information software module configured to determine a present or future state of the weather proximate vehicle 50 or other location.

Classifier 24 of control system 12 of vehicle 50 may be configured to detect objects in the vicinity of vehicle 50 dependent on input signals x. In such an embodiment, output signal y may include information characterizing the vicinity of objects to vehicle 50. Actuator control command 20 may be determined in accordance with this information. The actuator control command 20 may be used to avoid collisions with the detected objects.

In embodiments where vehicle 50 is an at least partially autonomous vehicle, actuator 14 may be embodied in a brake, a propulsion system, an engine, a drivetrain, or a steering of vehicle 50. Actuator control commands 20 may be determined such that actuator 14 is controlled such that vehicle 50 avoids collisions with detected objects. Detected objects may also be classified according to what classifier 24 deems them most likely to be, such as pedestrians or trees. The actuator control commands 20 may be determined depending on the classification. The control system 12 may utilize the hyper network to help train the network for adversarial conditions, such as during poor lighting conditions or poor weather conditions of the vehicle environment, as well as an attack.

In other embodiments where vehicle 50 is an at least partially autonomous robot, vehicle 50 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 20 may be determined such that a propulsion unit, steering unit and/or brake unit of the mobile robot may be controlled such that the mobile robot may avoid collisions with identified objects.

In another embodiment, vehicle 50 is an at least partially autonomous robot in the form of a gardening robot. In such embodiment, vehicle 50 may use an optical sensor as sensor 16 to determine a state of plants in an environment proximate vehicle 50. Actuator 14 may be a nozzle configured to spray chemicals. Depending on an identified species and/or an identified state of the plants, actuator control command 20 may be determined to cause actuator 14 to spray the plants with a suitable quantity of suitable chemicals.

Vehicle 50 may be an at least partially autonomous robot in the form of a domestic appliance. Non-limiting examples of domestic appliances include a washing machine, a stove, an oven, a microwave, or a dishwasher. In such a vehicle 50, sensor 16 may be an optical sensor configured to detect a state of an object which is to undergo processing by the household appliance. For example, in the case of the domestic appliance being a washing machine, sensor 16 may detect a state of the laundry inside the washing machine. Actuator control command 20 may be determined based on the detected state of the laundry.

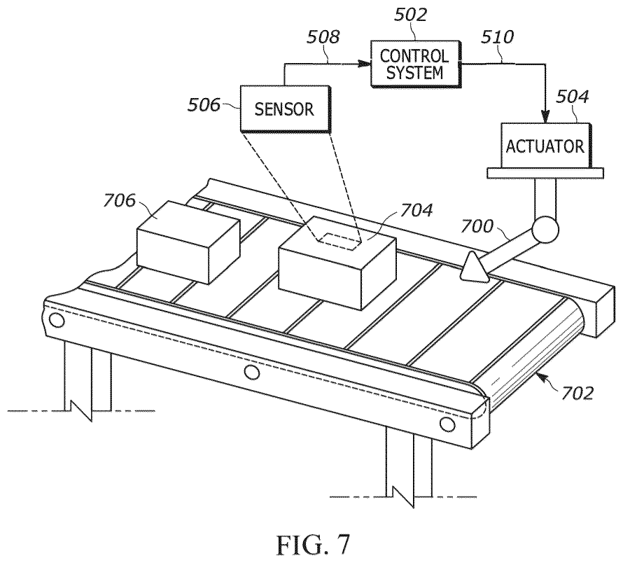

FIG. 7 depicts a schematic diagram of control system 12 configured to control system 100 (e.g., manufacturing machine), such as a punch cutter, a cutter or a gun drill, of manufacturing system 102, such as part of a production line. Control system 12 may be configured to control actuator 14, which is configured to control system 100 (e.g., manufacturing machine).

Sensor 16 of system 100 (e.g., manufacturing machine) may be an optical sensor configured to capture one or more properties of manufactured product 104. Classifier 24 may be configured to determine a state of manufactured product 104 from one or more of the captured properties. Actuator 14 may be configured to control system 100 (e.g., manufacturing machine) depending on the determined state of manufactured product 104 for a subsequent manufacturing step of manufactured product 104. The actuator 14 may be configured to control functions of system 100 (e.g., manufacturing machine) on subsequent manufactured product 106 of system 100 (e.g., manufacturing machine) depending on the determined state of manufactured product 104. The control system 12 may utilize the hyper network to aide the machine learning network for adversarial conditions, such as during poor lighting conditions or working conditions difficult for the sensors to identify conditions, such as lots of dust.

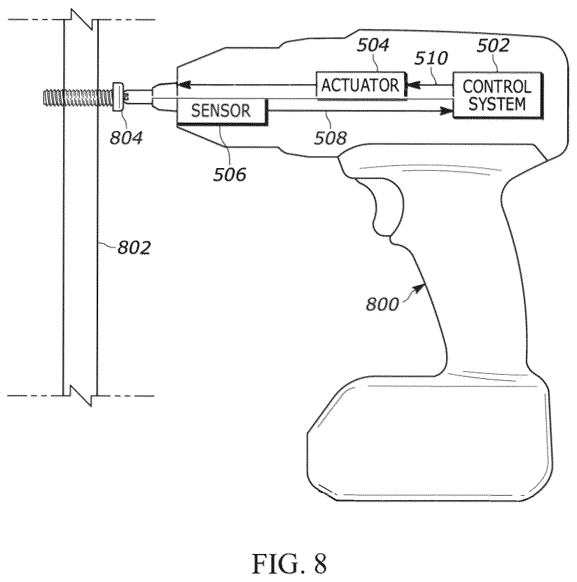

FIG. 8 depicts a schematic diagram of control system 12 configured to control power tool 150, such as a power drill or driver, that has an at least partially autonomous mode. Control system 12 may be configured to control actuator 14, which is configured to control power tool 150.

Sensor 16 of power tool 150 may be an optical sensor configured to capture one or more properties of work surface 152 and/or fastener 154 being driven into work surface 152. Classifier 24 may be configured to determine a state of work surface 152 and/or fastener 154 relative to work surface 152 from one or more of the captured properties. The state may be fastener 154 being flush with work surface 152. The state may alternatively be hardness of work surface 152. Actuator 14 may be configured to control power tool 150 such that the driving function of power tool 150 is adjusted depending on the determined state of fastener 154 relative to work surface 152 or one or more captured properties of work surface 152. For example, actuator 14 may discontinue the driving function if the state of fastener 154 is flush relative to work surface 152. As another non-limiting example, actuator 14 may apply additional or less torque depending on the hardness of work surface 152. The control system 12 may utilize the hyper network to aide the machine learning network for adversarial conditions, such as during poor lighting conditions or poor weather conditions. Thus, the control system 12 may be able to identify environment conditions of the power tool 150.

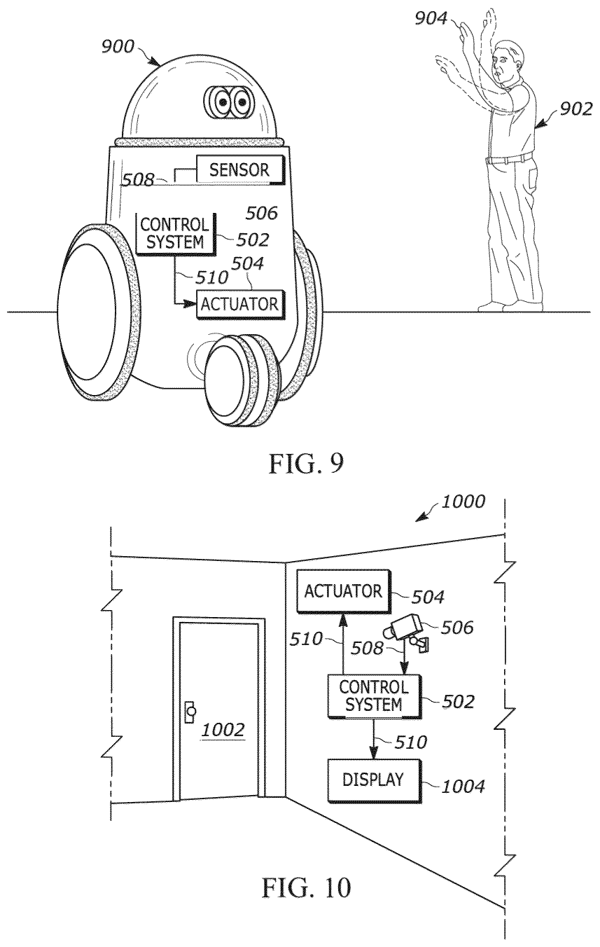

FIG. 9 depicts a schematic diagram of control system 12 configured to control automated personal assistant 900. Control system 12 may be configured to control actuator 14, which is configured to control automated personal assistant 900. Automated personal assistant 900 may be configured to control a domestic appliance, such as a washing machine, a stove, an oven, a microwave or a dishwasher.

Sensor 16 may be an optical sensor and/or an audio sensor. The optical sensor may be configured to receive video images of gestures 904 of user 902. The audio sensor may be configured to receive a voice command of user 902.

Control system 12 of automated personal assistant 900 may be configured to determine actuator control commands 20 configured to control system 12. Control system 12 may be configured to determine actuator control commands 20 in accordance with sensor signals 18 of sensor 16. Automated personal assistant 900 is configured to transmit sensor signals 18 to control system 12. Classifier 24 of control system 12 may be configured to execute a gesture recognition algorithm to identify gesture 904 made by user 902, to determine actuator control commands 20, and to transmit the actuator control commands 20 to actuator 14. Classifier 24 may be configured to retrieve information from non-volatile storage in response to gesture 904 and to output the retrieved information in a form suitable for reception by user 902. The control system 12 may utilize the hyper network to help train the machine learning network for adversarial conditions, such as during poor lighting conditions or poor weather conditions, as well as motion blur or glass blur. Thus, the control system 12 may be able to identify gestures during such conditions.

FIG. 10 depicts a schematic diagram of control system 12 configured to control monitoring system 250. Monitoring system 250 may be configured to physically control access through door 252. Sensor 16 may be configured to detect a scene that is relevant in deciding whether access is granted. Sensor 16 may be an optical sensor configured to generate and transmit image and/or video data. Such data may be used by control system 12 to detect a person's face. The control system 12 may utilize the hyper network to help train the machine learning network for adversarial conditions during poor lighting conditions or in the case of an intruder of an environment of the control monitoring system 250.

Classifier 24 of control system 12 of monitoring system 250 may be configured to interpret the image and/or video data by matching identities of known people stored in non-volatile storage 26, thereby determining an identity of a person. Classifier 24 may be configured to generate and an actuator control command 20 in response to the interpretation of the image and/or video data. Control system 12 is configured to transmit the actuator control command 20 to actuator 14. In this embodiment, actuator 14 may be configured to lock or unlock door 252 in response to the actuator control command 20. In other embodiments, a non-physical, logical access control is also possible.

Monitoring system 250 may also be a surveillance system. In such an embodiment, sensor 16 may be an optical sensor configured to detect a scene that is under surveillance and control system 12 is configured to control display 254. Classifier 24 is configured to determine a classification of a scene, e.g. whether the scene detected by sensor 16 is suspicious. Control system 12 is configured to transmit an actuator control command 20 to display 254 in response to the classification. Display 254 may be configured to adjust the displayed content in response to the actuator control command 20. For instance, display 254 may highlight an object that is deemed suspicious by classifier 24.

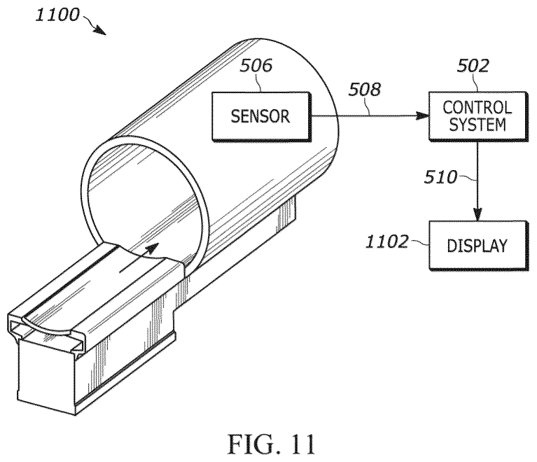

FIG. 11 depicts a schematic diagram of control system 12 configured to control imaging system 1100, for example an MRI apparatus, x-ray imaging apparatus or ultrasonic apparatus. Sensor 16 may, for example, be an imaging sensor. Classifier 24 may be configured to determine a classification of all or part of the sensed image. Classifier 24 may be configured to determine or select an actuator control command 20 in response to the classification obtained by the trained neural network. For example, classifier 24 may interpret a region of a sensed image to be potentially anomalous. In this case, actuator control command 20 may be determined or selected to cause display 302 to display the imaging and highlighting the potentially anomalous region. The control system 12 may utilize the diffusion model to help train the machine learning network for adversarial conditions during an X-ray, such as poor lighting.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for training a machine-learning network, comprising:
receiving an input data from a sensor, wherein the input data is indicative of image information, radar information, sonar information, or sound information;
generating a frequency spectrum associated with the input data, wherein the generating includes creating the frequency spectrum by applying a frequency domain transformation on the input data;
normalizing the frequency spectrum to generate a normalized frequency spectrum;
sending the normalized frequency spectrum to a hyper model configured classifying corruptions;
utilizing the normalized frequency spectrum as input to the hyper model in order to classify a corruption associated with the input data;
updating one or more weights associated with the classifier based on the corruption associated with the input data; and
outputting a classification associated with the input data utilizing the classifier with updated weights.

2. The computer-implemented method of claim 1, wherein generating the frequency spectrum is only associated with a first channel of the input data.

3. The computer-implemented method of claim 1, wherein the frequency domain transformation on the input data includes utilizing a wavelength transform.

4. The computer-implemented method of claim 1, wherein the corruption includes Gaussian noise, shot noise, motion blur, zoom blur, compression, or brightness changes.

5. The computer-implemented method of claim 1, wherein the frequency domain transformation on the input data utilizes a Fourier transform.

6. The computer-implemented method of claim 1, wherein the hyper model is configured to classify a clean image.

7. The computer-implemented method of claim 1, wherein the classifier is a pre-trained classifier.

8. The computer-implemented method of claim 1, wherein updating the one or more weights is in response to utilizing a look-up table defining batch norm statics associated with the corruption.

9. A system including a machine-learning network, comprising:
an input interface configured to receive input data from a sensor, wherein the sensor includes a camera, a radar, a sonar, or a microphone; and
a processor in communication with the input interface, wherein the processor is programmed to:
generate a frequency spectrum associated with the input data, wherein the generating includes creating the frequency spectrum by applying a frequency domain transformation on the input data;
normalize the frequency spectrum to generate a normalized frequency spectrum;
send the normalized frequency spectrum to a hyper model configured classifying corruptions;
utilizing the normalized frequency spectrum as input to the hyper model in order to classify a corruption associated with the input data;
update one or more weights associated with the classifier based on the corruption; and
output a classification associated with the input data utilizing the classifier with updated weights.

10. The system of claim 9, wherein the processor is programmed to update the one or more weights associated with the classifier utilizing a look-up table or directly updating the one or more weights.

11. The system of claim 9, wherein the frequency spectrum includes a Fourier transform of the input data.

12. The system of claim 9, wherein the frequency spectrum includes a wavelength transform of the input data.

13. The system of claim 9, wherein the hyper model is a three-layer fully connected neural network.

14. The system of claim 13, wherein the three fully connected layers include a size of 1024 neurons, 512 neurons, and 16 neurons.

15. A computer-program product storing instructions which, when executed by a computer, cause the computer to:
receive an input data from a sensor, wherein the input data is indicative of image information, radar information, sonar information, or sound information;
generate a frequency spectrum associated with the input data by applying a frequency domain transformation on the input data;
normalize the frequency spectrum to generate a normalized frequency spectrum;
inputting the normalized frequency spectrum to a hyper model configured classifying corruptions;
classify a corruption associated with the input data based on an output of the hyper model;
update the classifier based on the corruption; and
output a classification associated with the input data utilizing the updated classifier.

16. The computer-program product of claim 15, wherein the instructions cause the computer to update one or more weights associated with the classifier based on a lookup table identifying information associated with the corruption.

17. The computer-program product of claim 15, wherein the instructions cause the computer to update one or more weights associated with the classifier.

18. The computer-program product of claim 15, wherein the frequency domain transformation includes a Fourier transform.

19. The computer-program product of claim 15, wherein the hyper model includes three layers.

20. The computer-program product of claim 15, wherein the instructions cause the computer to update one or more weights of the classifier utilizing a look-up table defining batch norm statics associated with the corruption.
